(19) United States
(12) Patent Application Publication
(10) Pub. No.: US 2010/0306701 A1
(43) Pub. Date: Dec. 2, 2010

(54) Creation, Previsualization, Communication, and Documentation of Choreographed Movement

(76) Inventor: Sean Glen, Cypress, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/788,179

(22) Filed: May 26, 2010

Related U.S. Application Data
(60) Provisional application No. 61/182,508, filed on May 29, 2009.

(51) Int. Cl. H04N 5/91; G06F 3/048

(52) U.S. Cl. 715/810; 386/E05.003

(57) ABSTRACT

A method for documenting choreographed motion. A music track may be stored on a storage device coupled to a computing device. A plurality of dance counts may be associated with the music track. Text notes may be associated with at least some of the dance counts. Respective time stamps may be associated with the dance counts and text notes. The computing device may play the music track while synchronously displaying the text notes based on the associated time stamps.

### RELATED APPLICATION INFORMATION

This patent claims priority from provisional patent application 61/182,508, filed May 29, 2009, entitled “Creation, Previsualization, Communication, Education, Documentation, and Rehearsal of Choreographed Movement”, incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to methods and systems for documenting and communicating dance and other choreographed motions.

2. Description of the Related Art

For decades choreographers have been struggling to document and communicate dance in a way similar to the music industry with notation and a written score. There have been varying degrees of success with this approach. To date, there has been no notation technique or format that has been embraced by the everyday working choreographers and teachers in the dance community. The fundamental issues are the complexity of body movements possible during dance and other choreographed motion.

Attempting to notate the infinite variations and nuance of dance in only a written format requires a complex and technical language. A commonly taught dance notation language is Laban Notation, first published in 1928 by the Hungarian choreographer Rudolf von Laban. Other dance notation languages include Benesh Movement Notation, and Sutton Dance Writing. Each of these languages attempts to document motion using complex symbol sets that, to the uninitiated, may resemble ancient cuneiform script writing. However, most artists may not want or have the time to learn and retain fluency in a non-intuitive technical language.

Dance and other choreographed motion is commonly documented by video recordings of performances or rehearsals. Video is good for communicating the emotion, the mood, the quality and some of the details of a performance. However video is two-dimensional and does not communicate spatial relationships well. Video may not communicate the upstage/downstage position of performers accurately and cannot communicate the position or actions of a performer behind another performer or off camera. Additionally, learning or recreating a dance or other choreographed motion from only a performance video is a time-consuming and tedious process. It is very difficult to determine the specific motion or step, the direction, and the beginning or ending count of a motion from a video.

### DESCRIPTION OF THE DRAWINGS

FIG. 1 is a graphical depiction of a choreography description document (CDD) for documenting and communicating choreographed movement.

FIG. 2 is a screen capture of a display presentation of portions of a CDD.

FIG. 3 is a depiction of a display presentation of portions of a CDD.

FIG. 4 is a flow chart of a method for generating a CDD.

FIG. 5 is a flow chart of a method for defining dance counts.

FIG. 6 is a flow chart of a method for adding notes to a CDD.

FIG. 7 is a flow chart of a method for defining paths.

FIG. 8 is a block diagram of a computing device.

FIG. 9 is a depiction of content on a storage device.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Within this patent, the term “choreographed motion” means an individual or group performance of elaborate movements, steps, actions, or skills synchronized within the group and/or to music or time. Examples of choreographed motion include all styles of dance, figure skating, rhythmic gymnastics, cheer, synchronized swimming, acrobatics, and theatrical staging of performers and scenic elements. Choreographed motion may be performed by one or more dancers, skaters, divers, swimmers, or other performers, all of whom will be referred to herein as “performers”.

Choreographed motion is commonly performed to music. However, choreographed motion does not require music accompaniment. Within this patent, the term “beats” refers to a recurring periodic accent that occurs within rhythmic music. The term “dance counts” refers to names or labels used to count the rhythm of a choreographed motion. Dance counts are commonly called out by a choreographer or motion designer during rehearsals of choreographed motion. The notation or terminology used for dance counts may be different from that used by a musician to count the music. Dance counts may be synchronized with the beats of music that accompanies the choreographed motion, but individual dance counts need not directly align with music beats. Dance counts may be faster or slower than the music beats, and dance counts may be spaced periodically or irregularly. The term “count style” means a repetitive pattern of counts used to count the rhythm of a choreographed motion. The count style may be different for different choreographers and/or different performance genres.

Choreographed motion is typically performed within a bounded physical space. For example, choreographed motion may be performed on a theatrical stage, a ballroom floor, a swimming pool, a skating rink, or a portion of a gymnasium floor, all of which will be referred to herein as a “stage”. A stage may include, in some cases, “off-stage” portions that are not visible to an audience or spectators.

The term “track” means a data set configured to be retrieved and played or displayed essentially synchronously with other data sets or tracks. When played, two tracks are considered to be “synchronous” and “synchronized” if a time offset between the tracks is imperceptible to a typical human observer. For example, a 1998 recommendation by the International Television Union (ITU) indicated that the human threshold for detecting audio/video time offsets was +45 milliseconds (audio preceding video) to −125 milliseconds (audio lagging video). Currently, the Advanced Television System Committee recommends that the sound track of a television program should not lead the corresponding video image by more than 15 milliseconds or lag the video image by more than 45 milliseconds. Within this range, the sound and video may be considered synchronized although they are not absolutely synchronous.

Description of Methods

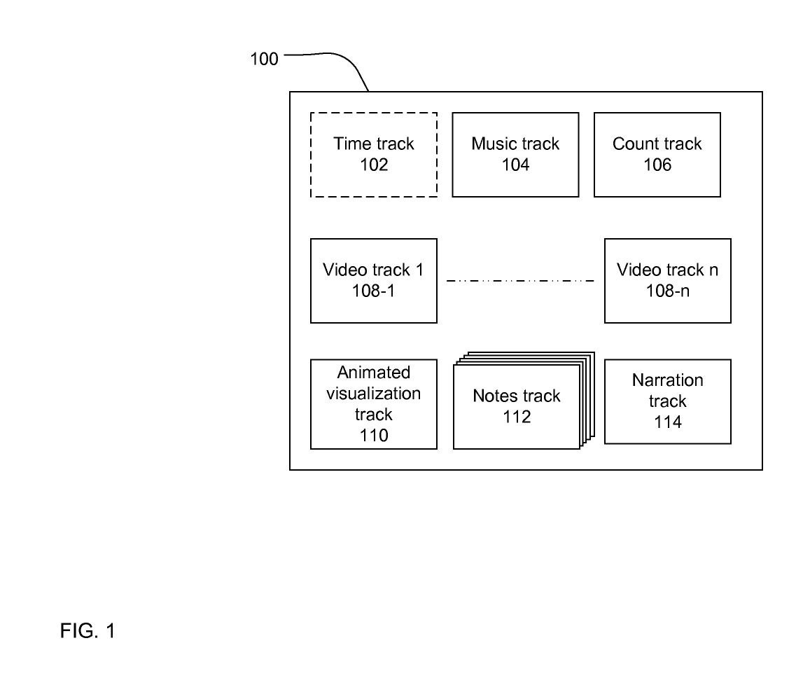

FIG. 1 is a graphical representation of a multimedia document 100 representative of a choreographed motion performance. The multimedia document 100, herein termed a “choreography description document” (CDD), may be used for creation, visualization, communication, and documentation of choreographed motion. The CDD 100 may include a time track 102 to which the choreographed motion is performed. The CDD 100 may include a music track 104 recording the music to which the choreographed motion is performed. The CDD 100 may include a count track 106 that contains data defining dance counts that divide the time track and or the music recorded on the music track into time intervals.

The CDD 100 may include one or more video tracks 108-1 to 108-n recording choreographed motion performed to the music recorded in the music track 104. For example, the CDD 100 may include a first video track 108-1 recording a front wide angle view of a stage, and one or more additional video tracks recording other views of a performance such as close-up views of individual performers. The CDD 100 may include a visualization track 110 containing data required to generate and display an animated perspective or top-down view of the relative positions and movements of performers on the stage using icons or virtual representations of the performers commonly known as avatars.

The CDD 100 may include a notes track 112 containing one or more pages of notes and instructions defining the performers' actions at regular time intervals throughout a performance. The notes track may include notes defining performers' actions at some or all of the dance counts identified by the count track 106. In contrast to Laban Notation or other symbolic dance notations, the notes track may contain notes written in ordinary language using the customary vocabulary for a particular type of dance or choreographed motion. The notes track 112 may include separate pages of notes for each performer or group of performers. The CDD 100 may also include one or more narration tracks, which may be an audio track recording a choreographer's verbal notes and instructions.

All of the music track 104, the count track 106, the one or more video tracks 108-1 to 108-n, the animated visualization track 110, the notes track 112, and the one or more narration tracks 114 may be configured such that two or more tracks, in any combination, may be played or presented synchronized to each other and to a common time track 102. The time track 102 may be realized by time stamps embedded within some or all of the other tracks.

The music track 104, the count track 106, the one or more video tracks 108-1 to 108-n, the animated visualization track 110, the notes track 112, and the one or more narration tracks 114 may be stored in separate data structures or files or may, in some cases be integrated to common data structures. Each track may be stored using a file format appropriate for the type of data. Each stored track may include embedded time stamps, synchronization mark, and/or other embedded information to facilitate synchronization of multiple tracks.

The one or more video tracks 108-1 to 108-n may be stored as separate video data files using one or more conventional video file formats such as a Windows Media Video (WMV) files, Audio-Video Interchange (AVI) files, Quicktime Movie (MOV) files, MPEG video files (MPG, MP4), or other video file formats. The music track and the narration track may be stored in uncompressed form in wave (WAV) or audio interchange file (AIF) files. The music track and the narration track may be stored in compressed form in MP3 (Motion Picture Experts Group layer 3) or Windows Media Audio (WMA) or some other audio file format. Video and audio files may be stored in a multimedia format such as an MP4 or AVI file.

The notes track may be stored as a text file, a flat database file such as a comma-separated value (CSV) file, an XML file, or some other data file format. The count track may be stored in a separate file or may be incorporated into the file containing the notes track.

The animated visualization track may be stored as a BVH (Biovision heirarchy), 3DS (3ds Max), C4D (Cinema 4D), XML (extended markup language), Java or Flash file containing data necessary to regenerate an animated display of performers' positions synchronously with one or more other tracks.

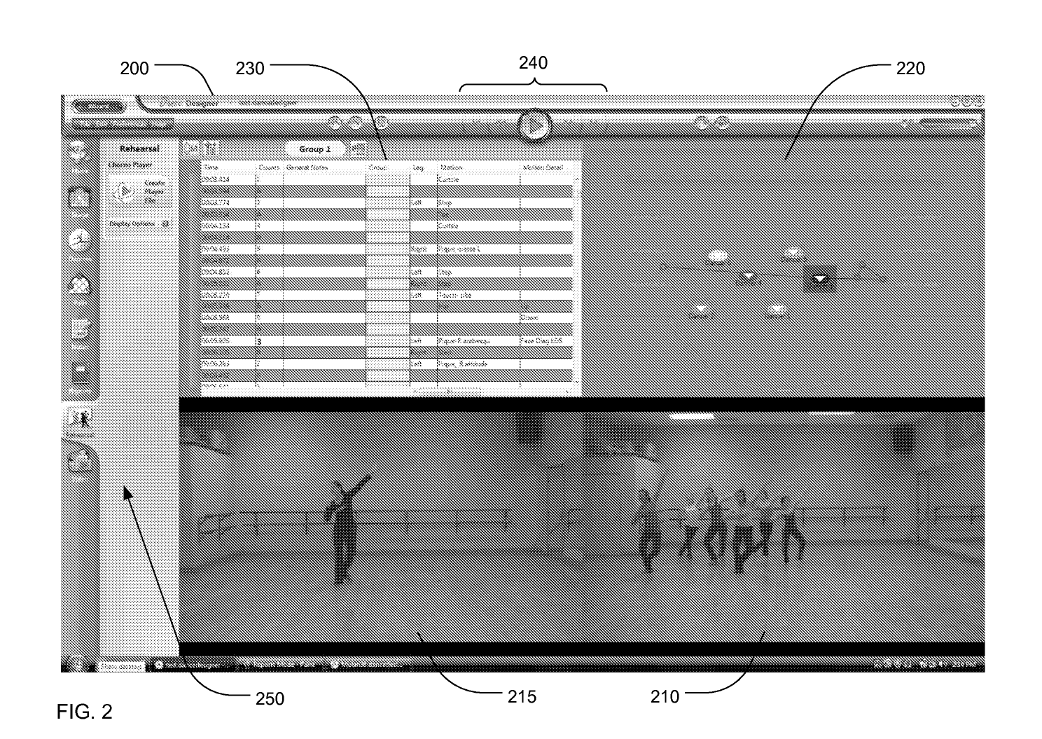

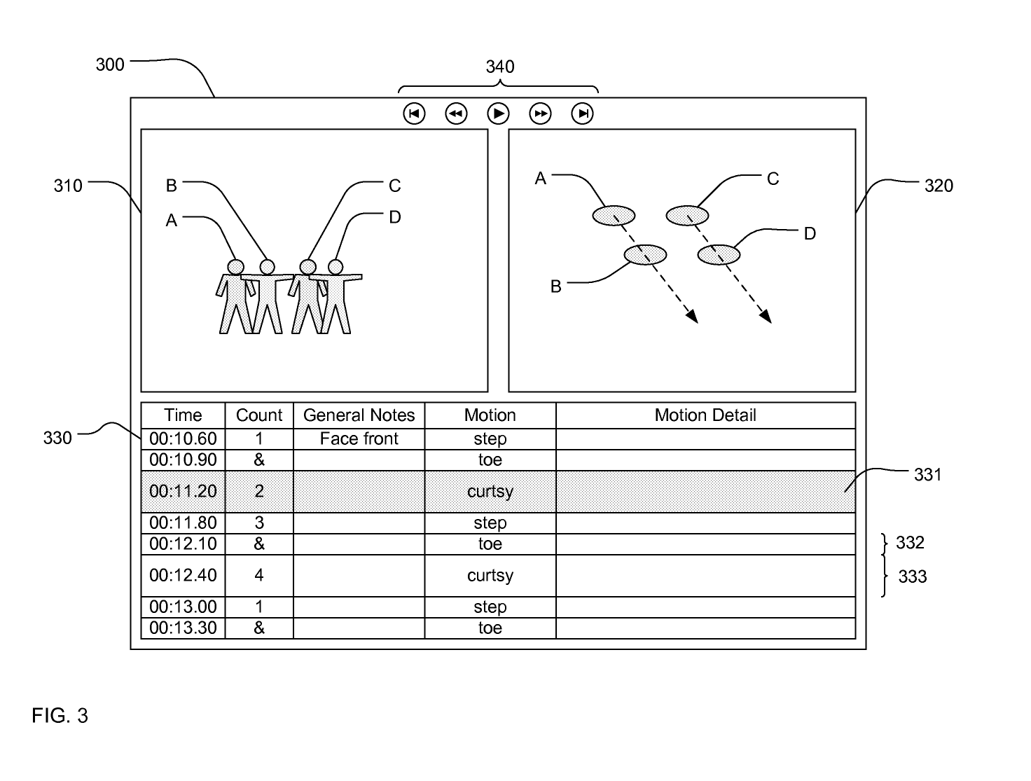

FIG. 2 is a capture of a display screen 200 presenting a portion of a CDD. FIG. 3 is a graphical representation of a display screen 300 presenting a portion of a different CDD. Portions of FIG. 2 that may be difficult to read due to small character size may be understood through reference to FIG. 3. Each display screen 200, 300 may be divided into a plurality of display windows, or regions, that show different content. The displayed content in each display window may be synchronized to a common music track and/or time track.

Each display screen 200, 300 may include one or more video display windows 210, 215, 310. For example video display windows 210, 310 may present an ensemble of dancers rehearsing a performance, and video display window 215 may present a featured dancer rehearsing the same performance. Video display windows 210 and 215 may be synchronized to a common music track such that the two video display windows 210, 215 represent the same time point within the performance.

Each display screen 200, 300 may include a respective visualization display window 220, 320 indicating the locations and movements of performers on stage. The visualization display window may use graphical symbols or avatars to indicate performers and may be animated to indicate the movements of the performers. For example, the visualization display window 220 may show a top-down view of the positions of the six dancers in the ensemble shown in video window 215. In the example of FIG. 3, the visualization display window shows a top-down view of the positions of four performers A, B, C, D who are also shown in the video window 310. The visualization display windows 220, 320 may be synchronized with the respective music tracks and respective video windows 210/215, 310. A visualization display window may also include representations of stationary objects such as scenery items and stage features such as curtains and entry/exit points.

Each display screen 200, 300 may contain a notes display window 230, 330 which may display notes, instructions, and other information related to a performance, all of which will be referred to herein as “notes”. As opposed to previous motion documentation systems that rely upon complex symbolic representations of human movement, the notes contained in a CDD may be entered and displayed in plain text, using the vocabulary and syntax appropriate to a specific choreographed motion genre. Each note may be associated with one or more dance counts, and the notes may be displayed within the note display windows 230, 330 synchronized with a music track and with the video and visualization display windows 210, 215, 220, 310, 320.

Notes may be associated with some or all of the dance counts. For convenience in reading the notes, notes may be displayed as an array of rows and columns of text fields. Each dance count may correspond to a row of notes, and the columns may correspond to specific categories of notes. Categories of notes may include, for example, the following:

| | |
|---|---|
| General | Used for quick reminder notes, identifying performance dance |
| Notes | sections, lyrics, other general information; |
| Leg | Used for defining the working or supporting leg (i.e. Left, |
| | Right, Both, etc.); |
| Motion | Used for detailing the basic step, motion or action using |
| | terminology specific to the performance genre (i.e. Arabesque, |
| | Pirouette, Scissor Leap, etc.); |
| Motion | Used for details about the step, motion or action (i.e. forward, |
| Detail | back, double, triple, etc.); |
| Body | Used for details about the body direction relative to the |
| Direction | performance space (i.e. downstage, stage left, stage right, etc.) |
| Quality | Used to describe the quality of the step, motion or action (i.e. |
| | slow, fast, percussive, etc.); |
| Arms | Used for detailing arm movement or position (i.e. 1st-5th, up, |
| | down, etc.); |
| Head | Used for detailing head movement or position (i.e. up, down, |
| | roll left, etc.); |
| Detail | Used for any additional details of the choreography. |
| Notes | |

In the example of FIG. 3, the notes categories within the notes display window 330 include “time”, “count”, “general notes”, “motion”, and “motion detail”. A notes display window on a high resolution monitor may include additional columns and categories as appropriate to the performance genre.

Dance counts need not represent equal time intervals. In the example of FIG. 3, the performance is counted “one and two, three and four”, where “one”, “two” “three” and “four” may align with the beats of the music track such that “and” occurs between successive beats. In this case, the time duration associated with “two” and “four” may be twice the time duration associated with each of “one”, “and”, “three”, and “and”. As shown in FIG. 3 (see 332, 333 for example) the relative heights of the rows in the notes display window may reflect the relative duration of the associated dance counts.

Since each row of the notes display may be associated with a respective dance count, the vertical axis of the notes display represents time. The content of the notes display window 230, 330 may scroll vertically in synchronism with an accompanying music track, the video display window 210/215, 310, and the visualization display window 220, 320. Alternatively, the content of the notes display window 230, 330 may be stationary and a highlight bar 331 or other indicator of the present count may move vertically in synchronism with the accompanying music track. When the highlight bar 331 reaches the bottom of the notes display window, the content of the notes display window may be replaced and the highlight bar positioned at the top of the notes display window on the next dance count.

The display screens 200, 300 may include virtual buttons 240, 340 to manage the playback and display of a CDD. The virtual buttons 240, 340 may include play, stop, rewind, fast forward, and other functions similar to the controls of a conventional tape recorder. The display screen 200 also includes virtual control buttons 250 to select various modes of operation for creating, storing, and playing a CDD (not shown in FIG. 3). A CDD display screen may also include controls for slowing the playback of a CDD such that the CDD can be viewed in slow motion.

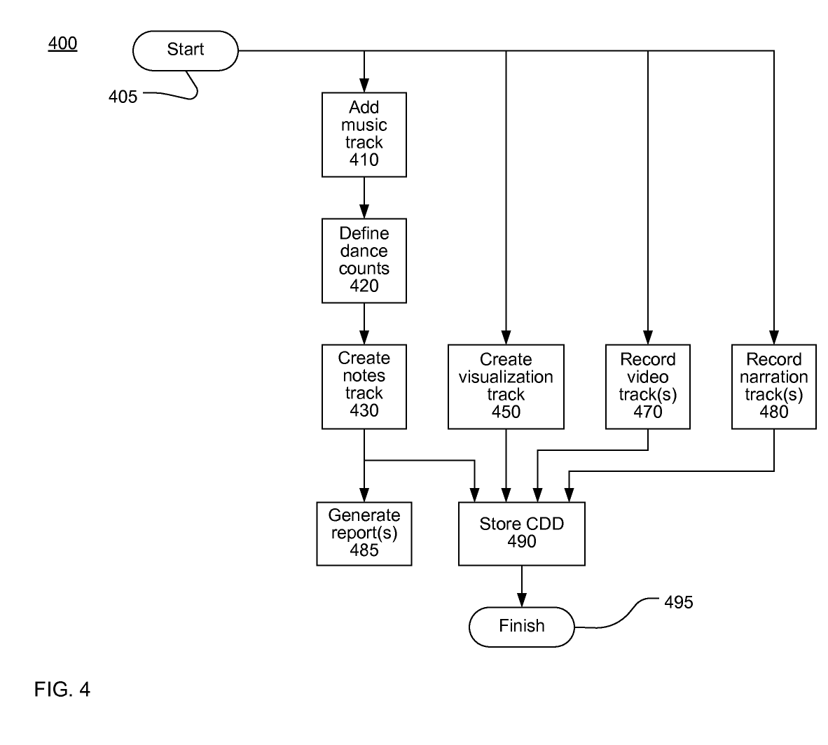

Referring now to FIG. 4, a process 400 for creating a CDD may start at 405 and finish at 495 after all desired elements of the CDD have been stored. At 410 a music track may be added to the CCD. The music track may be added by recording a live performance; by downloading a music file via a network; by retrieving a previously stored music file; by combining, merging, or otherwise editing one or more music files; or by some other method.

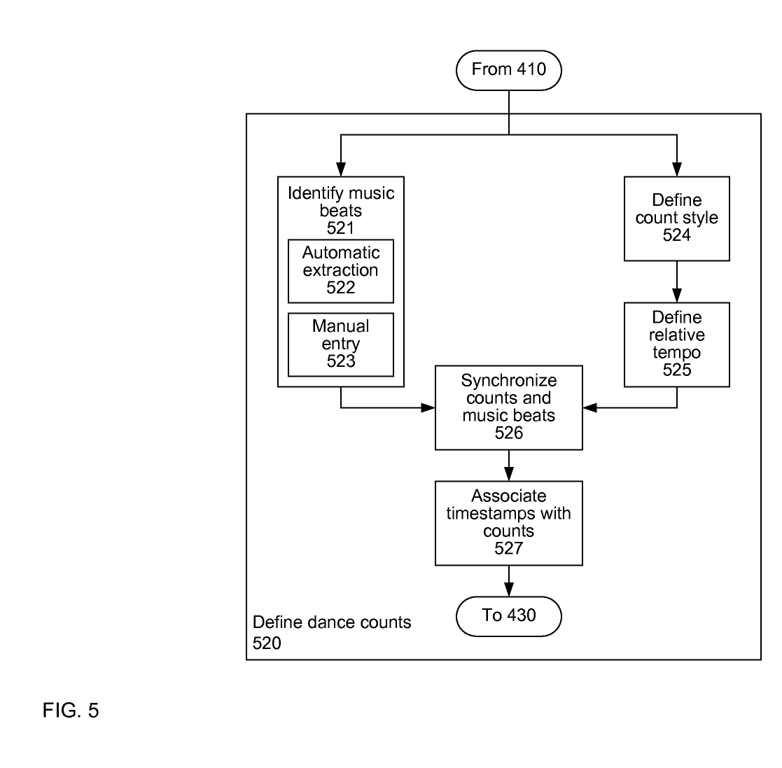

At 420 dance counts may be defined and synchronized with the music track from 410. Referring now to FIG. 5, an exemplary process 520 for defining dance counts may start after the music track is added at 410. At 521, the beats of the music recorded on the music track may be identified. The beats may be automatically extracted at 522 from the music track. The beats may be manually entered at 523, for example by tapping a mouse button in time to the music track. The beats may be identified by some other method.

At 524, a count style may be defined. The count style may be selected from a menu of predetermined count styles or may be generated by a user. To generate a count style, a user may enter a desired sequence of count names and indicate which of the count names are aligned with beats of the music. At 525, a relative tempo between the dance counts and the music beats may be defined. Typically, dance counts may either align with the music beats, or may be one-half or twice the tempo of the music beats. As shown in the example, the time intervals between successive dance counts need not be constant, such that some dance counts align with music beats and some dance counts fall between music beats.

At 526, the dance counts may be synchronized with the music track. The pattern of dance counts defined at 524 and 525 may be repeated for the duration of the music track and at least some of the dance counts may be aligned with respective music beats. At 527, respective time stamps may be associated with the dance counts. Each time stamp may indicate a specific time, for example measured from the start of the music track, when the associated dance count occurs.

The music recorded on a music track may change tempo or meter during a performance. In this situation, the process 520 for defining dance counts may include additional steps, not shown in FIG. 5, for partitioning the music track into sections and defining a different count style and/or relative tempo for each section. In some situations, the music beats, count style, and/or relative tempo may be predefined (for example, if the same music was previously used in a choreographed motion performance, or if the dance counts are imported from a previous CDD). In such case some or all of the steps 522, 523, 524, and 525 may be omitted.

In situations where choreographed motion is not to be performed to music, the actions at 521 and 526 may be omitted. The tempo of the dance counts, for example in counts per minute, may be defined at 525, and a respective time stamp may then be associated with each dance count at 527.

Referring back to FIG. 4, after dance counts are defined at 420, a notes track may be created at 430. As shown in FIG. 2 and FIG. 3, a notes track can be visualized as a spreadsheet in which each row corresponds to a specific dance count and thus to a specific instant in time indicated by a timestamp associated with the dance count, and each column corresponds to a category of information.

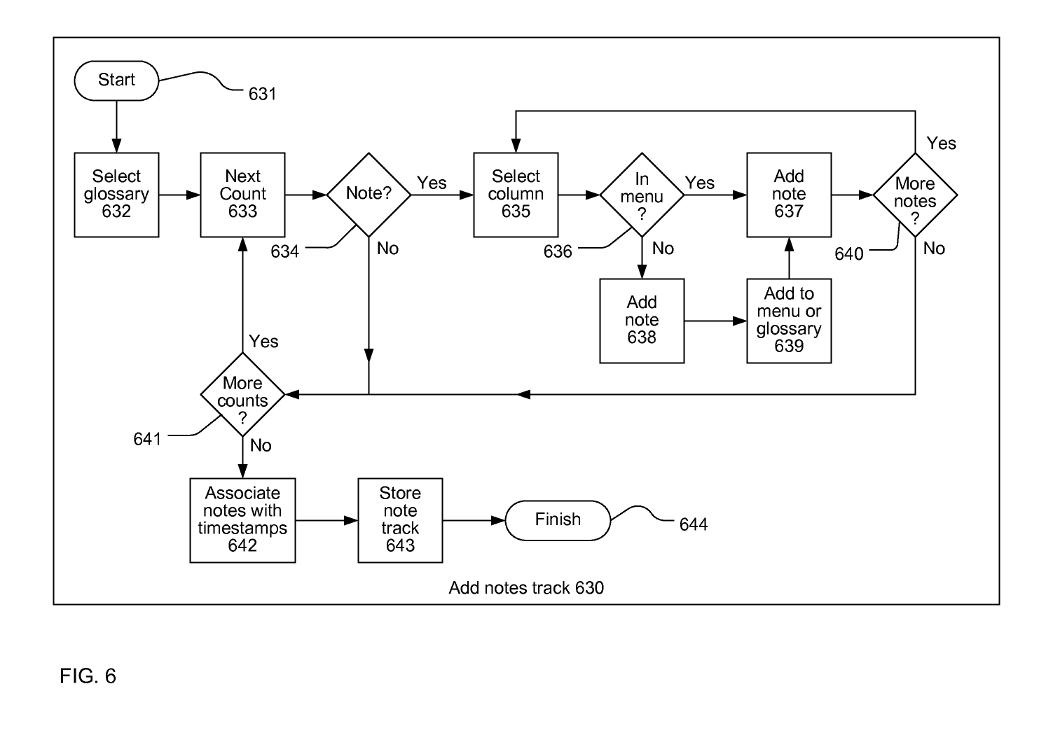

Referring now to FIG. 6, an exemplary process 630 for adding a notes track may begin at 631 after dance counts are defined, and may end at 644. The process 630 may be cyclic in nature. Additionally, the process 630 may be performed a plurality of times, either sequentially or in parallel, to enter notes for a corresponding plurality of performers or groups of performers.

The vocabulary used by choreographers and performers of a particular choreographed motion genre may differ from the vocabulary used for other genres. For example, the terms used to describe ballet movements are distinct from the terms used to describe figure skating or tap dancing. To facilitate entering notes for a particular performance, at 632, an appropriate glossary may be selected from a plurality of glossaries containing terms associated with corresponding choreographed motion genres.

After a glossary is selected at 632, a first count corresponding to a first row of notes may be selected at 633. At 634, a determination may be made if any note should be entered for the selected count. If a determination is made at 634 that at least one note should be entered, the process 630 may proceed to 635 where a specific column or category to receive a note may be selected, for example by clicking on the cell at the intersection of the row corresponding to the selected count and the selected category.

At 636, a determination may be made if the desired note is available in a menu associated with the selected category. If the desired note is available, the desired note may be designated, for example from a pull-down menu, and added to the notes track at 637. If the desired note is not available, the user may enter the desired note manually at 638. The user may optionally add the manually entered note to the menu for the selected column and/or to the selected glossary at 639. Additionally, the user may be provided with an opportunity to enter a description or definition of the note. The description or definition of the added note may be attached to the note track for future reference.

After a note is added at 637, a determination may be made at 640 whether or not additional notes will be added for the current dance count. If additional notes are to be added for the current dance count, the actions from 635 to 640 may be repeated as required.

When a determination is made at 634 that no notes need to be added for a particular dance count, or when a determination is made at 640 that no additional notes need to be added, a determination may be made at 641 whether or not the performance includes more counts. When a determination is made at 641 that the performance includes additional notes, the actions from 633 to 641 may be repeated cyclically until all notes have been entered.

When the performance does not include more counts, which is to say when notes have been entered for the entire performance, time stamps may be associated with each of the accumulated notes at 642. Since each note relates to a specific dance count, the time stamp associated with each dance count may be, in turn, associated with the related notes. The accumulated notes and associated timestamps may be stored as the note track at 643, and the process 630 may finish at 644.

The creation of a notes track may be facilitated by a GUI specifically designed for entering notes to a CDD. The notes GUI may provide a menu for selecting a glossary from a plurality of predefined glossaries containing notes and terms associated with a corresponding plurality of choreographed motion genres. The notes GUI may also provide a mechanism for a user to create a new glossary or to add terms to or remove terms from an existing glossary. The notes GUI may provide, for at least some categories of notes, pull-down menus or other mechanisms for populating the notes track with terms from the selected glossary. The pull-down menus may be hierarchical, such that selection of a note for a given category may limit or control the pull-down menus for other note categories. The notes GUI may provide editing features such as copying, cutting, and pasting blocks of note and importing blocks of notes from previously stored CDDs.

Referring again to FIG. 4, after a notes track have been created at 430, one or more reports listing all or portions of the notes track may be generated and printed at 485. For example, individual reports may be generated for each dancer or group of dancers containing only those notes relevant to the recipient's participation in a performance.

A visualization track documenting positions of one or more performers on a stage may be created at 450. The visualization track may include data defining a sequence of time points and corresponding positions, relative to the stage, of one or more performers at each time point. The visualization track may contain additional data such as data defining an orientation, of facing direction, for each performer at each time point. The visualization track may contain additional data to be used for generating an image and/or an animated avatar demonstrating the performer's movements. The visualization track may be created before or after the music track, count track, and/or notes track are added to the CDD at 410, 420, and 430, respectively.

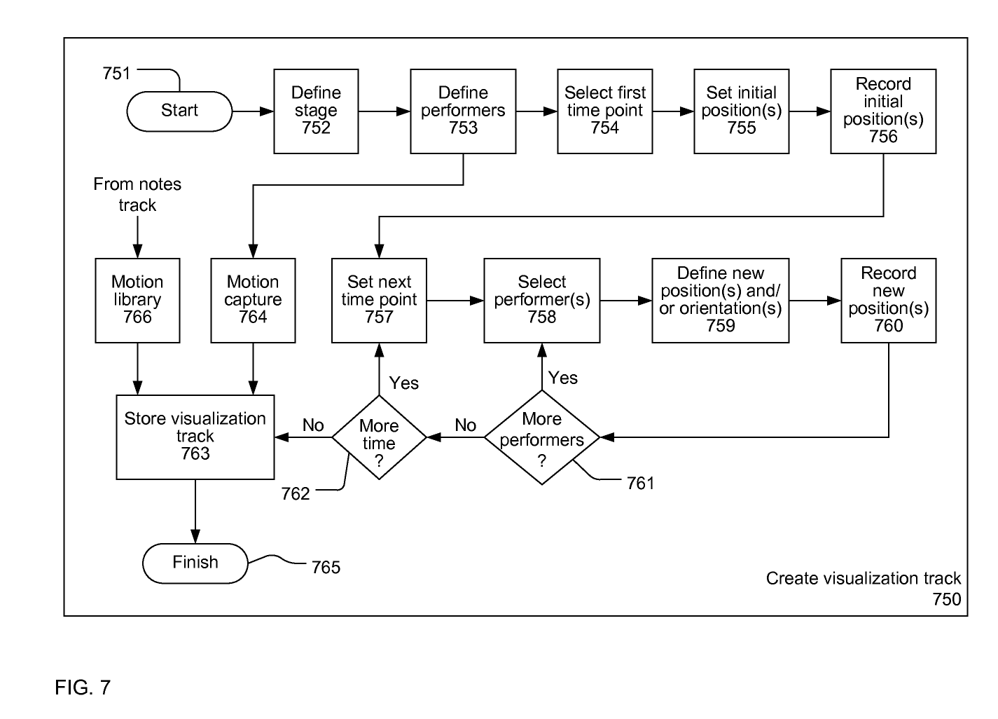

Referring now to FIG. 7, an exemplary process 750 for creating a visualization track may begin at 751 and end at 765 after the positions and movements of all performers have been defined for the duration of a performance. The process 750 may be cyclic in nature. Additionally, the process 750 may be performed a plurality of times, either sequentially or in parallel, to enter the positions and movements for a corresponding plurality of performers.

In the example of FIG. 7, an assumption has been made, for ease of explanation, that the positions of all performers are defined at each time point before defining a subsequent time point. The actions from 755 to 759 of the process 750 could be performed in different order to create an identical visualization track.

At 752, a stage may be defined using a stage GUI. A stage may be represented, for example, as a plan view of a flat stage from above. A stage may be defined in two dimensions or as a three-dimensional structure. An initial stage configuration may be selected from a library of predetermined stage forms or may be imported from one or more conventional drawing formats such as Autodesk's Drawing (DWG) and Drawing Exchange Format (DXF) files and conventional image formats such as (JPG), (PNG), and (PDF) files. The initial stage configuration may then be scaled and configured to represent a specific physical venue where a performance will occur. Curtains, scenery items, entry and exit paths, and other features that effect or limit the motions of performers may be added. The stage GUI may, for example, include a menu or library of predetermined icons that may be selected or dragged onto the plan view of the stage to represent common features. The stage GUI may also include drawing tools to add unique features.

After a stage has been defined at 752, one or more performers may be added to the stage at 753. A performer GUI may be provided to facilitate adding the performers from a selected library of predetermined icons and/or avatars. For example, icons or avatars representing performers may be selected or dragged from a menu onto the plan view. Icons and/or avatars may be imported from one or more conventional drawing formats such as Autodesk's (DWG) and Drawing Exchange Format (DXF) files and conventional image formats such as (JPG), (PNG), and (PDF) files. The performer GUI may also include tools to modify attributes such as scale, color, name, size, and icon or avatar style.

At 754, a first time point may be selected. The first time point may be, for example, coincident with a start of the music track. At 755 the initial positions of the performers may be defined. Performer positions may be defined in two dimensions or, where appropriate for the stage, three dimensions. For example, each performer icon or avatar may be dragged or otherwise placed in their respective positions at the first time point. Defining the position of the performers may include defining an orientation, or facing direction, for each performer and/or defining a posture or pose for each avatar. For some performances, the initial position of some or all of the performers, and thus the performer icons, may be off-stage, or outside of the portion of the stage visible to an audience. At 756, the initial time point and the initial positions of the performers may be recorded or saved.

At 757, a next time point in the sequence of time points may be set. If a music track has already been added to the CDD, the next time point may be set, for example by, a user clicking a mouse button while listening to the music track. If a dance count track has already been added to the CDD, the next time point may be set by selecting a specific dance count. The next time point may be set absolutely by entering a specific time after the start of the performance. The next time point may be set in some other manner.

After the next time point has been set at 757, one or more performers may be selected at 758 and repositioned at their respective new locations at 759. One or more performers may be selected at 758 by clicking on the performer icon or avatar in the plan view, entering a performer number or name, selecting the performer from a text list of performers, or in some other manner. The performers may be repositioned at 759 by dragging the selected icon or avatar to new positions in the plan view, by stepping the selected icon or avatar using keyboard arrow keys, by entering a desired movement distance and direction, or in some other manner. At 759, other data, such as an orientation or pose of the one or more performers, may also be entered. The new time point and the new position of each performer may be recorded or saved at 760.

After the selected one or more performers have been repositioned at 759 and saved at 760, a determination may be made at 761 whether or not all performers have been appropriately repositioned for the current time point. If more performers need to be repositioned, the actions from 757 through 761 may be repeated as needed. Although not shown in FIG. 7, the process 750 may also allow repositioning or reconfiguration of items other than performers, such as scenery items or props.

When all performers have been repositioned for the current time point, a determination may be made at 762 whether or not there are more time points in the sequence of time points, which is to say whether or not the movement of the performers has been defined for the entire choreographed motion performance. The actions from 757 to 762 may be repeated cyclically until the movement of the performers has been defined for the entire choreographed motion performance.

The creation of a visualization track may be facilitated by a visualization GUI specifically designed for entering performer positions and movements to a CDD. The visualization GUI may provide copy, paste, mirror, rotate and spline tools for the customization and manipulation of the performer's visualization track. The visualization GUI may also provide a mechanism for editing the position and time points of recorded locations of the performers. The visualization GUI may provide editing features such as copying, cutting, and pasting movements from previously stored CDDs.

As an alternative to manual entry of performer positions, the movements of some or all of the performers may be imported from a motion capture system at 764. A motion capture system may, for example, record a rehearsal or performance from multiple viewpoints using multiple video or infrared cameras. To facilitate the motion capture, the performers may wear special costumes fitted with reflectors or light sources. The multiple video images may then be analyzed to determine the position and orientation of the performers over time. Data representing the positions of performers may be imported from a motion capture system at 764 instead of, or in addition to, data entered manually at 754-762. For example, the movements of a featured performer may be imported from a motion capture system and the movements of background performers may be entered manually. For further example, a portion of a performance may be entered via motion capture and the balance may be manually entered.

Data imported from a motion capture system may include data defining the position of one or more performers over time. The data imported from the motion capture system may also include data describing each performer's motion, orientation, posture, limb position, head position, and other data that may be used to animate the avatars representing the performers.

Data to animate the avatars representing performers may also be obtained from a motion library 766 based on notes contained in a notes track created at 430. Dance and other choreographed motion may be composed of, at least in part, standard motions, moves, or steps performed in a specific sequence. Motion capture clips or animated clips of these standard motions may be contained in a motion library 766. At any given dance count, the notes contained in the notes track may define a motion performed by a performer and the data entered at 754 to 762 may define the position and orientation of the performer. The combination of data from the motion library and data entered at 754-762 may be used to animate the avatar representing the performer.

After the movements of the performers have been defined for the entire choreographed motion performance, time and position data accumulated at 756 and 760 and/or motion capture data from 764 and 766 may be stored as the visualization track at 764, and the process 750 may finish at 765.

Returning now to FIG. 4, one or more video tracks may be recorded at 470. When a video track is recorded after a music track has been established at 410, the video track may be recorded the choreographed motion performed to the music track. Recording the choreographed motion preformed to the music track ensures continuous synchronization between the music and video tracks over the duration of the performance. Conversely, when a video track is recorded prior to establishing a music track (for example when a CDD is created to document an existing performance), the music track may be recorded simultaneously or extracted from an audio portion of the video recording.

In some circumstances, a video track may be recorded where it is not possible to guarantee continuous synchronization between the video track and the music track of an existing CDD. For example, a video track may be recorded of a performance using a live orchestra, where the tempo of the music may differ from the tempo of the music track in the existing CDD. In such case, the video track may be incorporated into a new CDD, and a new music track may be extracted from the video track. Once the beats of the new music track are defined, some or all of dance counts, a notes track, a visualization track, and a narration track may be imported from the existing CDD and synchronized to the beats of the new music track to complete the new CDD.

One or more optional audio narration tracks may be recorded at 480. A narration track may typically be recorded after at least some of a music track, a notes track, a visualization track, and a video track have been added to a CDD. Each narration track may document the choreographer's or performer's thoughts and instructions that are not conveniently communicated via the notes track.

After the desired tracks have been recorded or created at 410, 420, 430, 450, 470, and 480, the completed CDD may be stored at 495. The completed CDD may include a plurality of audio, video, and data files containing the various tracks and a linkage file containing additional data as needed to synchronize the play-back of the other files.

Description of Apparatus

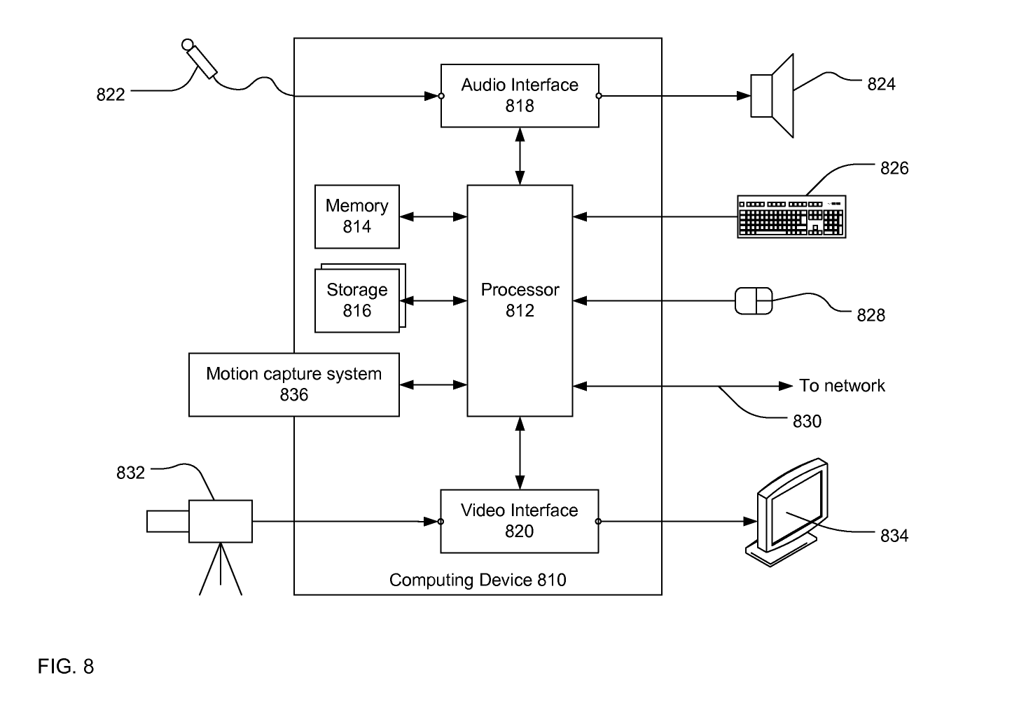

FIG. 8 shows a block diagram of a computing device 810 for documenting and communicating choreographed motion. The computing device 810 may be any device with a processor 812, memory 814 and a storage subsystem 816 that may execute instructions including, but not limited to, personal computers, server computers, computing tablets, set top boxes, video game systems, personal video recorders, telephones, personal digital assistants (PDAs), portable computers, and laptop computers. The computing device 810 may include software, hardware and firmware for providing the functionality and features described here.

The computing device 810 may have at least one interface 830 to couple to a network or to external devices. The interface 830 may be wired, wireless, or a combination thereof. The interface 830 may couple to a network which may be the Internet, a local area network, a wide area network, or any other network. The interface 830 may couple to an external device which may be a printer, an external storage device, or some other device. The computing device 810 may also interface with one or more operator input devices such as a keyboard 826 and/or a mouse, trackball, or other pointing device 828.

The computing device 810 may include an audio interface unit 818. The audio interface unit 818 may have at least one audio input port to accept input audio signals from external audio sources, such as microphone 822, and at least one audio output port to provide output audio signals to one or more audio output devices such as speaker 824. The audio interface unit 818 may have a plurality of audio output ports to provide audio signals to a plurality of audio output devices which may include multiple speakers and/or headphones. The audio input and output ports may be wired to the audio sources and audio output devices. The audio input and output ports may be wireless, and may receive and transmit audio signals using a wireless infrared or RF communication protocol, which may include Bluetooth, Wi-Fi, or another wireless communication protocol.

The computing device 810 may include a video interface unit 820. The video interface unit 820 may have a video input port to accept input video signals from external sources, such camera 832, and at least one video output port to provide display signals to a display device 834.

The computing device 810 may interface with or include, at least in part, a motion capture system 836. The motion capture system 836 may include a plurality of video or infrared cameras (not shown in FIG. 8) that view one or more performer's movements from a respective plurality of vantage points. The images captured by the cameras may be analyzed by a computer, which may be the computing device 810, to determine the position and/or orientation of the performers. When the analysis is performed by a computer other than the computing device 810, motion capture data may be imported by the computing device 810 via a dedicated interface or via the network connection 830.

The computing device 810, the audio interface unit 818, and the video interface unit may include one or more of logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The computing device 810 may run an operating system, including, for example, variations of the Linux, Unix, MS-DOS, Microsoft Windows, Palm OS, Solaris, Symbian, and Apple Mac OS X operating systems. The processes, functionality and features described herein may be embodied in whole or in part in software operating on the computing device and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by the computing device 810 and other components are performed by other devices.

The storage subsystem 816 may include one or more storage devices. A storage device may be any device that allows for reading and/or writing to a storage medium. Storage devices include hard disk drives, DVD drives, flash memory devices, and others. These storage media include, for example, magnetic media such as hard disks, floppy disks and tape; optical media such as compact disks (CD-ROM and CD-RW) and digital versatile disks (DVD and DVD±RW); flash memory cards; and other storage media. The storage system 816 may include a storage medium that stores software programs that, when executed, cause the computing device to perform the processes and functions described herein. A typical configuration of the storage subsystem 816 may include a hard disc drive for storing software programs and data, and a removable-media storage device such as a flash memory or writable optical disc, for recording transportable CDD files.

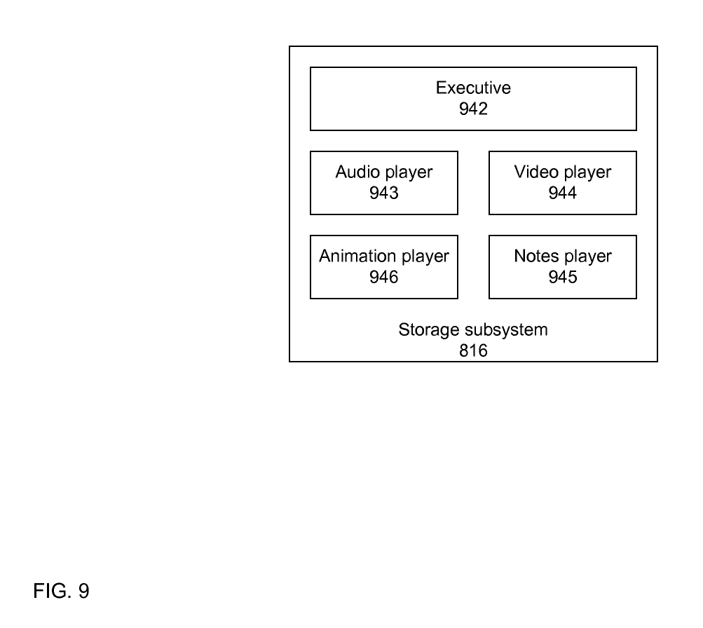

Referring now to FIG. 9, a storage system 816 may store a variety of software elements that enable a computing device to perform the processes and functions described herein. The software elements may include an audio player 943 and a video player 944, which may be separate software elements or an integrated multimedia player. The audio player 943 and/or the video player 944 may be one or more commercially available players, such as a Windows Media Player, a Quicktime player, a Flash player, or some other commercially available media player. The storage system 816 may store multiple audio or video players if needed to accommodate a variety of audio and video media formats.

The software elements stored in the storage subsystem 816 may include a notes player 945, which may be specifically configured to retrieve notes tracks and display text notes synchronously with an audio track as previously described. The software elements stored in the storage subsystem 816 may also include an animation player 946, which may be specifically configured to retrieve visualization tracks and display performer movement animations synchronously with an audio track as previously described.

The software elements stored in the storage subsystem 816 may also include an executive program 942. The executive program 942 may manage the operation of the audio player 943, the video player 944, the notes player 945 and the animation player 946 to create, store, and present CDDs as previously described. The executive program 942 may manage the recording of music, narration, and video tracks. The executive program 942 may generate various GUIs used during creation of a CDD. The executive program 942 may accept user inputs relating to dance counts, notes, performer movements, and other data. The executive program 942 may generate and store count tracks, notes tracks, and animated visualization tracks based on the user inputs.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for documenting choreographed motion, comprising:
storing a music track on a storage device coupled to a computing device
associating a plurality of dance counts with the music track
associating text notes with at least some of the dance counts
associating respective time stamps with the dance counts and text notes
the computing device playing the music track and synchronously displaying the text notes based on the associated time stamps.

2. The method of claim 1, further comprising:
the computing device generating a notes track including data defining the text notes and the associated time stamps and storing the notes track on the storage device.

3. The method of claim 1, wherein associating a plurality of dance counts further comprises:
identifying beats of the music recorded on the music track
accepting user inputs designating a count style
associating dance counts with the beats in accordance with the count style.

4. The method of claim 3, wherein identifying beats of the music comprises the computing device automatically extracting the beats.

5. The method of claim 1, wherein displaying the stored text notes comprises displaying an array of cells defined by a plurality of rows and a plurality of columns, wherein the rows of the array correspond to dance counts and associated time stamps, and the columns of the array correspond to note categories.

6. The method of claim 5, wherein associating text notes to at least some of the text notes further comprises:
the computing device accepting a user input designating a specific dance count and a specific note category
the computing device displaying a menu listing a plurality of notes from a note glossary associated with a selected choreographed motion genre
the computing device accepting a user input designating a note from the menu.

7. The method of claim 6, wherein note glossary comprises a plurality of menus linked in a hierarchical structure.

8. The method of claim 6, further comprising:
the computing device accepting a user selection of the choreographed motion genre from a predetermined menu of genres
the computing device retrieving a note glossary associated with the selected choreographed motion genre.

9. The method of claim 1, further comprising:
the computing device accepting data defining a sequence of time points and positions, relative to a predefined stage, of one or more performers at each of the time points
the computing device generating, based on the sequence of time points and performer positions, and displaying an animation of the performers' positions synchronously with playing the music track and displaying the notes track.

10. The method of claim 9, wherein displaying an animation further comprises:
displaying at least one avatar that, for at least some dance counts, simulates motions selected from a motion library containing a plurality of motion capture clips, wherein the motions are selected based on the text notes associated with at least some dance counts.

11. The method of claim 9, further comprising:
the computing device generating and storing, on the storage device, a visualization track containing data defining the sequence of time points and corresponding performer positions.

12. The method of claim 1, further comprising:
storing one or more video tracks on the storage device
the computing device displaying one or more of the stored video tracks and one or both of the text notes and the animation synchronously with playing the music track.

13. The method of claim 1, further comprising:
storing an audio commentary track on the storage device
the computing device playing the audio commentary track synchronously with displaying one or both of the text notes and the animation.

14. A method for communicating choreographed motion, comprising:
a computing device playing a music track retrieved from a storage device
the computing device retrieving text notes descriptive of the choreograph motion and associated time stamps from a notes track stored on the storage device
the computing device displaying the text notes synchronously with playing the music track based on the associated timestamps.

15. The method of claim 14, wherein displaying the text notes comprises:
displaying an array of cells defined by a plurality of rows and a plurality of columns, wherein the rows of the array correspond to time intervals, and the columns of the array correspond to note categories, and at least some of the cells contain text notes.

16. The method of claim 14, further comprising:
the computing device retrieving, from a visualization track stored on the storage device, data defining a sequence of time points and corresponding positions, relative to a predefined stage, of one or more performers
the computing device generating, based on the retrieved data, and displaying an animation of the one or more performers' positions synchronously with playing the music track and displaying the text notes.

17. The method of claim 16, further comprising:
the computing device displaying one or more video images retrieved from the storage device and one or both of the text notes and the animation synchronously with playing the music track.

18. The method of claim 16, further comprising:
the computing device playing an audio commentary track retrieved from the storage device synchronously with displaying one or both of the text notes and the animation.
